(19) United States
(12) Patent Application Publication
(10) Pub. No.: US 2011/0148308 A1
(43) Pub. Date: Jun. 23, 2011

(54) HANDHELD DEVICE HAVING LATERAL ILLUMINATION FOR KEYPAD

(76) Inventors: Wen-Ping Yu, Taipei County (TW); Tung-Po Chiu, Taipei County (TW)

(21) Appl. No.: 12/843,893

(22) Filed: Jul. 27, 2010

(30) Foreign Application Priority Data
Dec. 21, 2009 (TW) 098143890

(51) Int. Cl. H05B 37/02; F21S 4/00; F21V 11/00

(52) U.S. Cl. 315/149; 362/458; 362/227; 362/311.01; 315/291; 315/287; 320/137

(57) ABSTRACT

A handheld device includes a row of lighting elements configured at the side of its top body that faces a keypad of its bottom body for illuminating the keypad when the two bodies slide away for use. The lighting elements projects light in a direction nearly parallel with the keypad and toward the surface of the keypad, and illumination of the keypad is therefore accomplishable in various environmental conditions. The lighting elements may also be used for illuminating the keypad or displayed with different strength or bright and dark periods based on the ambient brightness, and based on the charging rate of the handheld device's rechargeable battery when the handheld device is being charged.

### BACKGROUND OF THE INVENTION

1. Field of the Invention

The invention relates to a handheld device, and more particularly, to a slider type handheld device that has a lighting element at a lateral side of its top cover for illuminating a keypad on a bottom cover when the two covers slide away with respect to each other, and the handheld device whose lighting element has various periods of alternating lighting strength according to the charging rate of a battery module.

2. Description of the Prior Art

Extended applications of handheld devices are continuously expanding in 3C industries. One or more keypad modules are configured thereon in most of handheld devices for allowing users to operate these devices in addition to direct operation by touching touch screens on the handheld devices illuminated by a backlight module. For simple multimedia devices, mobile communication devices having touch screens as the main input interface, personal digital assistants, or portable navigation devices, few additional buttons are quite satisfactory for users to operate beyond touch panel relating functions.

For other handheld devices that provide complicated input interface, however, the keypad becomes primary input interface for operating the devices. Examples can be found in mobile communication devices with QWERTY keyboards or remote controllers that provide a multitude of functions. In normally illuminated environment, those many buttons on the body of such handheld device can be recognized and operated easily. But in the environment lacking enough ambient light, when watching movies for example, it is quite inconvenient to operate these buttons of a TV remote controller, if there is no proper illumination for the handheld device.

The U.S. Pat. No. 5,568,367 discloses a remote controller having back lighting for the buttons which are light-transmissible for a lighting module configured underneath so that the buttons can be lit up by the lighting module, either totally or partially by use of lighting module capable of being controlled by zone once one or more buttons are pressed by users so that the remote controllers are recognizable and operatible in dark environment.

Although it is quite common to use such technology for handheld devices, say the remote controllers, it needs a plurality of additional control and illuminating components. Furthermore, the buttons themselves should be processed with a special way first, such as the in molding roller (IMR) or the laser engraving process. Cost for manufacturing the devices is inevitably increasing. As a result, the invention is seeking a simple device that has its keypad illuminated with relatively low cost. On the other hand, since handheld devices usually utilize rechargeable batteries as power sources, the invention also seeks to provide much more useful information showing indication of the charging rate of the batteries by use of present illumination component.

### SUMMARY OF THE INVENTION

The invention uses a low cost and indicating lighting element on the extensively used slider type handheld devices. When a top cover and a bottom cover of the handheld device slide away with respect to each other, the lighting element at the side of the top cover laterally illuminates a keypad on the bottom cover, providing an easier operation of the handheld device in dark environment. Meanwhile, the lighting element at the top cover can have various periods alternating its lighting strength between the maximum strength and the minimum strength according to the charging rate of the battery module for further indicating purpose.

The invention provides a handheld device including a first body and a second body. The first body includes a first keypad and slidably assembles with the second body. The second body includes a housing and a lighting element configured at a side of the housing. The light element is utilized for projecting light toward a surface of the first keypad when the first body slides relative to the second body to a predetermined position.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic front view of an embodiment of a handheld device according to the invention.

FIG. 2 is a schematic diagram showing functions performed at a side of the handheld device.

FIG. 3 is a schematic diagram showing the handheld device changes lighting strength of the lighting element according to the ambient brightness.

FIG. 4 illustrates a schematic diagram showing that the handheld device changes the frequency at which the lighting element changes lighting strength between the bright and dark statuses according to the ambient brightness.

FIG. 5 illustrates a schematic diagram showing that the handheld device changes the frequency at which the lighting element changes lighting strength between bright and dark statuses according to the charging rate.

### DETAILED DESCRIPTION

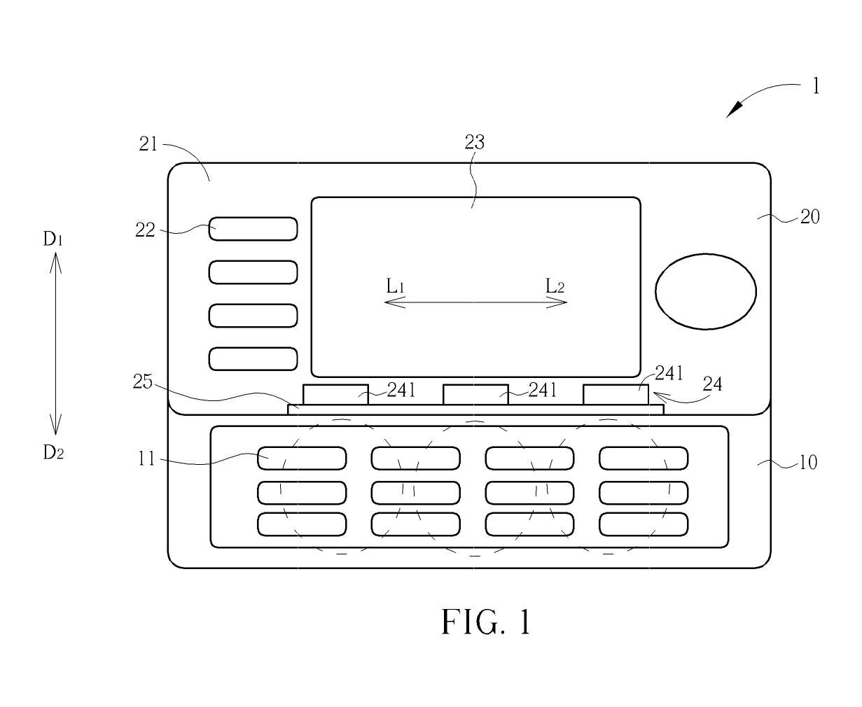

Please refer to FIG. 1. FIG. 1 is a schematic diagram of an embodiment of a handheld device 1 disclosed in the invention. The handheld device 1 is preferably a slider type remote controller that includes a first body 10 and a second body 20 capable of sliding with respect to each other. The first body 10 is in parallel slidable along direction D₁D₂ relative to the second body 20, to be closed or to be opened. When the first body 10 slides along direction Di relative to the second body 20 to be closed, the handheld device 1 has relatively small size and can be operated through the second body 20. When the first body 10 slides along direction D₂ relative to the second body 20 to be opened, the first body 10 is exposed for full operation.

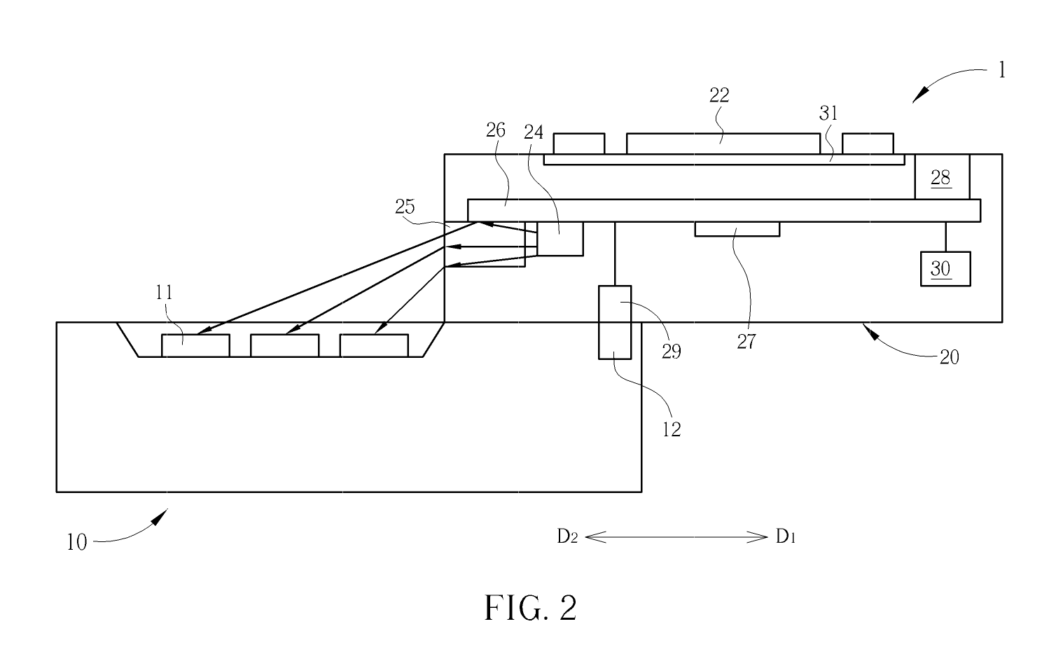

The first body 10 includes a first keypad 11, which has a plurality of buttons for complicated control, and the second body 20 includes a second keypad 22 and a display panel 23. Considering utility setup and convenience, the display panel 23 may be a touch panel or a common one, or directly removed from the handheld device 1, while the second keypad 22 may include opaque buttons that do not emit light, or use backlight illumination, such as a backlight element 31 in FIG. 2. The second keypad 22 may also use light-transmissible buttons such that the second keypad 22 may also be illuminated for smooth operation. Since either the first keypad 11 or the second keypad 22 needs proper illumination for easy operation such that the handheld device 1 can be operated in dark environment, the first keypad 11, in the embodiment of the invention, is further provided with illumination by a lighting element 24 disposed at a side of a housing 21 of the second body 20.

Please refer to FIG. 2. FIG. 2 is a schematic diagram showing functions performed at a side of the handheld device 1 in an embodiment. As FIG. 1 and FIG. 2 show, after the second body 20 and the first body 10 slide away with respect to each other to be opened, the lighting element 24 at the side, which faces the first keypad 11 of the first body 10, of the housing 21 of the second body 20 projects light toward the surface of the first keypad 11 to illuminate the first keypad 11 in a dark environment. In this embodiment, the lighting element 24 is composed of a plurality of light emitting diode (LED) chips 241, which locate at the side of the housing 21 of the second body 20 and align in a row along a direction parallel with the surface of the first keypad 11, wherein the side of the housing 21 faces a side of the first body 10. The plurality of LED chips 241 is illustratively aligned along direction L₁L₂ parallel with the long side of the first keypad 11 as shown in FIG. 1. In such way, each area of the first keypad 11 can be homogeneously and thoroughly covered by light emitted from the lighting element 24. Light emitted by each LED chip 241 is mainly projected toward the surfaces of different areas of the first keypad 11 in a manner that the projection dircection is substantially parallel with the surface of the first keypad 11. The first keypad 11 can be illuminated with sufficient light strength so that a user can clearly see buttons on the keypad 11. As a result, the lighting element 24 can effectively illuminate the keypad 11 with relatively small emitting power under such configuration. Moreover, electric power is also saved.

For example, an LED chip 241 has different emitting strength as different electric current is supplied to the LED chip 241. In a preferred embodiment of the invention, each LED chip 241 of the lighting element can receive 4-15 mA current, and 3-4 LED chips 241 are configured at one side of the housing 21 for thoroughly and uniformly illuminating the whole first keypad 11. Additionally, a diffuser 25 can further be configured between the side of the second body 20 (the side neighboring the first keypad 11) and the lighting element 24 such that light from the lighting element 24 may go through the diffuser 25 first before reaching the first keypad 11. Light emitted from each LED chip 241 is homogenized by the diffuser 25 and then projected toward the surface of the first keypad 11. Each LED chip 241 is a point light souce, but is effectively transferred as a surface source or a line source by the diffuser 25 so that illumination on the first keypad 11 is more uniform.

FIG. 2 shows that the lighting element 24 is controlled to emit light by a control unit 27 configured in the second body 20. Both the control unit 27 and the lighting element 24 are configured at a circuit board 26 in the second body 20. The second body 20 may further include a light sensor 28, a second triggering component 29 and a battery module 30, all of which being electrically connected to one another and configured at the circuit board 26. The first body 10 further includes a first triggering component 12 that is utilized to trigger the second triggering component 29, by either electromagnetically sensing or mechanically switching, when the first body 10 slides along direction D₂ relative to the second body 20 to an opened position as shown in FIG. 1 or FIG. 2. The control unit 27 then controls the lighting element 24 to illuminate the surface of the first keypad 11. As the first body 10 and the second body 20 are closed with respect to each other, the two triggering components 12, 29 are inactive and the lighting element 24 is turned off.

Additionally, the handheld device 1 may further include a light sensor that is used to adjust the light strength of the lighting element 24 under various ambient brightness for adaptive illumination and saving power. As shown in FIG. 2, the light sensor 28 outputs corresponding sensing voltage according to the ambient brightness, and the control unit 27 then controls the lighting element 24 to emit light with corresponding strength according to the outputted sensing voltage from the light sensor 28.

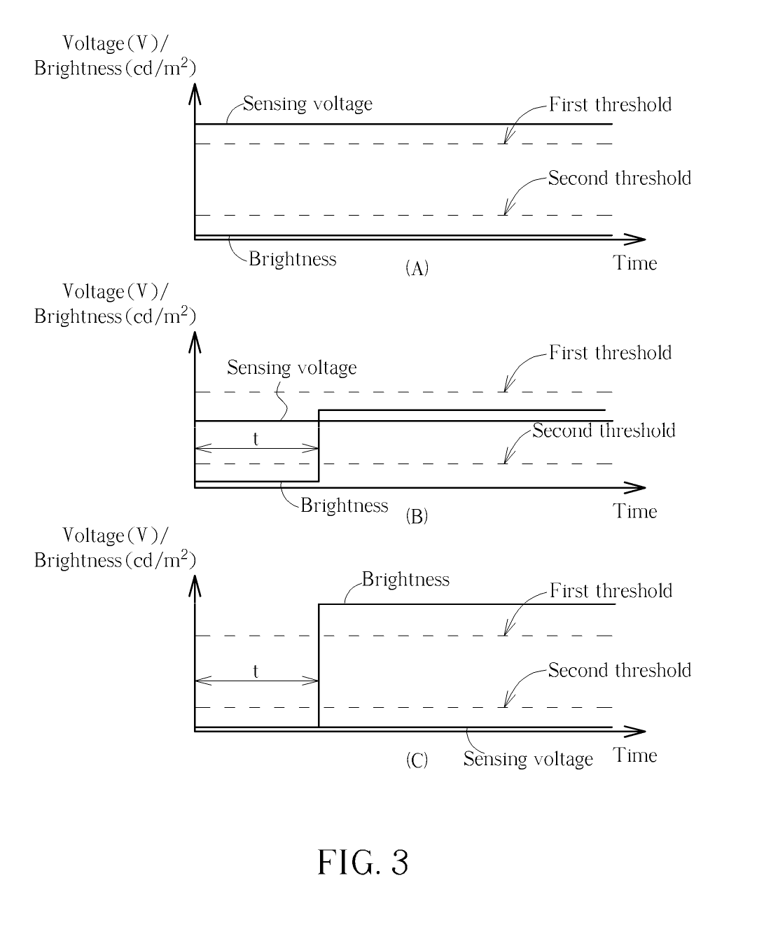

Please refer to FIG. 3. FIG. 3 is a schematic diagram showing that the handheld device 1 changes lighting strength of the lighting element 24 according to the ambient brightness. In the embodiment of the invention, two threshold values, a first threshold value and a second threshold value for example, may be set in connection with the sensing voltage about the ambient brightness. When the environment is relatively bright, the sensing voltage generated by the light sensor 28 that senses the ambient brightness would be greater than the first threshold value, as illustrated in part A of FIG. 3. With a bright environment, the handheld device 1 can be configured not to activate the keypad illumination function when the handheld device 1 is sliding opened, i.e., the control unit 27 controls the lighting element 24 not to emit light to prevent unnecessary power consumption. As the environment is relatively dark, the sensing voltage generated by the light sensor 28 that senses the ambient brightness would be smaller than the second threshold value, as illustrated in part C of FIG. 3. Now the first keypad 11 needs enough illumination for operation in such dark environment and the control unit 27 is configured to supply maximum current for the lighting element 24 (for example, each LED chip 241 can preferably receive 10-15 mA) to illuminate the first keypad 11 with the maximum strength.

When the ambient brightness is between the aforementioned two conditions, the light sensor 28 detects the ambient brightness and outputs a sensing voltage falling between the first threshold value and the second threshold value, as illustrated in part B of FIG. 3. At such situation, the handheld device 1 provides illumination for the first keypad 11 with a suitable extent according to the ambient brightness, where the strength of illumination is in inverse proportion to the ambient brightness so as to provide the user relatively comfortable operation experience. That is, as the ambient brightness gets brighter, the sensing voltage generated by the light sensor 28 is higher, and the control unit 27 controls the lighting element 24 to emit light with a relatively low strength according to the sensing voltage. On the contrary, as the ambient brightness gets darker, the sensing voltage generated by the light sensor 28 is lower, and the control unit 27 controls the lighting element 24 to emit light with a relative high strength according to the sensing voltage. By controlling the illuminating strength according to the ambient brightness, the handheld device 1 also reduces the power consumption and prolongs the life of its battery module. Additionally, FIG. 3 shows that the activation of the lateral illumination for the first keypad 11 may also be delayed once the first body 10 slides relative to the second body 20 to the opened position. The lighting element 24 is controlled to emit light after delaying a predetermined time t so that the invention can have more variety in application.

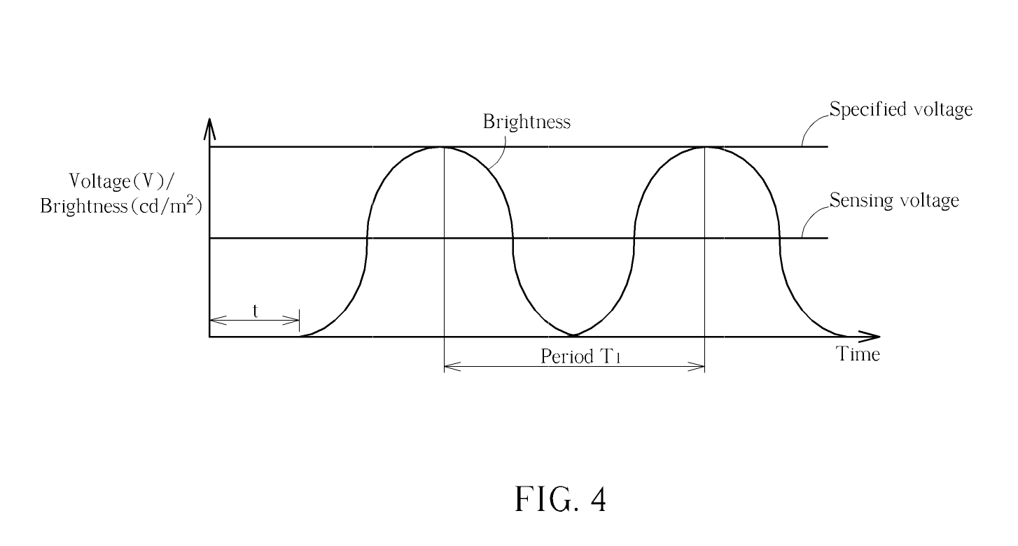

Besides the way as shown in FIG. 3 that the first keypad 11 is illuminated by steady strength according to the ambient brightness, in other embodiments of the invention, the lighting element 24 may also be controlled to illuminate the first keypad 11 in a slowly transition period (from the bright status to the dark status) according to the ambient brightness. FIG. 4 illustrates a schematic diagram showing that the handheld device 1 changes the frequency at which the lighting element 24 changes illumination between the bright and dark statuses according to the ambient brightness. Once the control unit 27 receives the sensing voltage X generated by the light sensor 28 detecting the ambient brightness, it controls the lighting element 24 by using pulse width modulation (PWM) method such that the lighting element 24 emits light in a period T₁ and changes its lighting strength between the maximum strength and the minimum strength. In a preferred embodiment the period T₁ can be deduced by the following equation:

T₁=1/(M−X);

where M is an input voltage required by the lighting element 24 to emit light with maximum strength or a specified voltage provided for the lighting element 24, and X is a sensing voltage generated by the light sensor 28 detecting the ambient brightness. As mentioned earlier, the sensing voltage X is in proportion with the ambient brightness and is set not to be greater than the specified voltage M of the lighting element 24. For example, if the specified voltage M of the lighting element 24 is 4.2 Volt, and as the light sensor 28 detects the ambient brightness and generates the sensing voltage X to be 3 Volt (meaning a darker environment), the period T₁ would be 0.8 second, which implies a faster alteration between brightness and darkness; as the light sensor 28 detects the ambient brightness and generates the sensing voltage X to be 4 Volt (meaning a brighter environment), the period T₁ would be 5 second, which implies a much slower alteration between brightness and darkness.

By use of such control method, when in brighter environment, the lighting element 24 of the handheld device 1 changes the strength between the brightest and the darkest statuses at a relatively slow pace, while in darker environment, the lighting element 24 changes the strength between the brightest and the darkest statuses at a relatively fast pace. The handheld device 1 can have various illumination effects according to the ambient brightness, and the time delay effect (t) as mentioned before and illustrated in FIG. 4 can also be implemented herein.

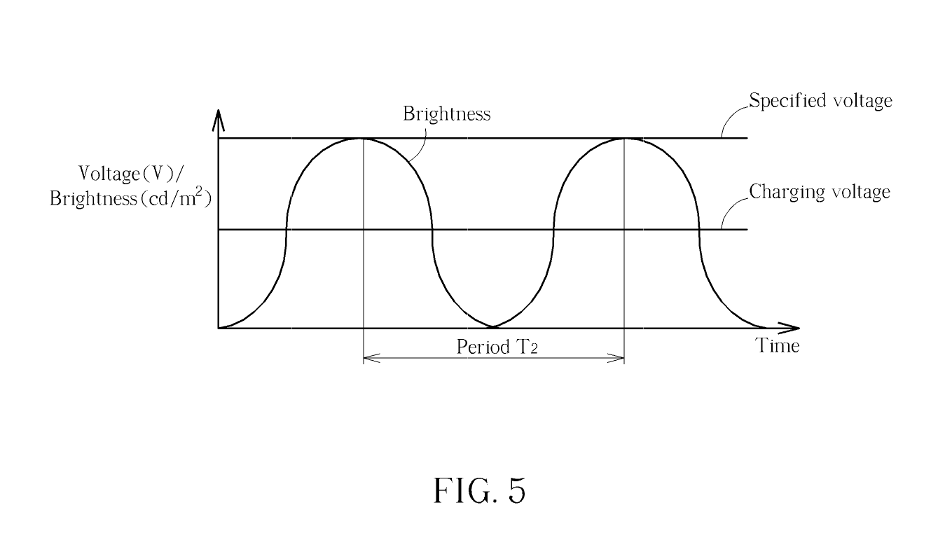

Please refer to FIG. 5. FIG. 5 illustrates a schematic diagram showing that the handheld device 1 changes the frequency at which the lighting element 24 changes illumination between the bright and dark statuses according to the charging rate. In addition to the function that the handheld device 1 controls the lighting element 24 to illuminate the first keypad 11 with a variety of effects when the first body 10 and the second body 20 are sliding to be opened, the lighting element 24 may further be used for other extensive applications. For example, the battery module 30 in FIG. 2, which is not limited to be configured at the second body 20, may be a rechargeable battery module that provides power for the handheld device 1. As the battery module 30 is being charged, whenever the handheld device 1 is set in a closed position or in the opened position, the lighting element 24 may further be controlled by the control unit 27 and utilized for displaying the charging rate of the battery module 30. In FIG. 5 for example, the battery module 30 has specified voltage N when its capacity is full. The battery module 30 also has a charging voltage V when it is being charged and the charging voltage V varies with the charging time. The control unit 27 controls the lighting element 24 by pulse width modulation (PWM) method as the battery module 30 is being charged such that the lighting element 24 emits light in a period T₂ and changes its lighting strength between its maximum strength and minimum strength to display the charging status of the battery module 30. In a preferred embodiment, the period T₂ can be deduced by the following equation:

T₂=1/(N−V);

where the charging voltage V increases with the percentage of completion of charging and reaches to the specified voltage N. As a result, when the charging voltage V of the battery module 30 is at a low level, which represents an initial charging stage or low percentage of charging completion, the lighting element 24 of the handheld device 1 is controlled to alternate between the brightest and the darkest statuses in a relatively fast pace; when the charging voltage V of the battery module 30 is at a high level, which represents a final charging stage or high percentage of charging completion, the lighting element 24 is then controlled to alternate between the brightest and the darkest statuses in a relatively slow pace. The lateral illumination of the handheld device 1 therefore provides effective indication of charging completeness.

The embodiments of the invention disclose a handheld device including a row of lighting elements configured at the side of its top body that faces a keypad of its bottom body for illuminating the keypad when the two bodies slide away for use. The lighting elements projects light in a direction nearly parallel with the keypad and toward the surface of the keypad, and illumination of the keypad is therefore accomplishable in various environmental conditions. The lighting elements may also be used for illuminating the keypad or displayed with different strength or bright and dark periods based on the ambient brightness, and based on the charging rate of the handheld device's rechargeable battery when the handheld device is being charged.

Those skilled in the art will readily observe that numerous modifications and alterations of the device and method may be made while retaining the teachings of the invention.

What is claimed is:

1. A handheld device, comprising:
a first body comprising a first keypad; and
a second body, wherein the first body slidably assembles with the second body, the second body comprising a housing and a lighting element configured at a side of the housing, the light element utilized for projecting light toward a surface of the first keypad when the first body slides relative to the second body to a predetermined position.

2. The handheld device of claim 1, wherein the lighting element comprises a plurality of light emitting diode (LED) chips that align in a row along the side of the housing and are parallel with the first keypad, the plurality of LED chips respectively projecting light toward the surface of different areas of the first keypad.

3. The handheld device of claim 1, further comprising a diffuser configured between the side of the housing and the lighting element for converting the light projected by the lighting element to a homogenous light source to be projected toward the surface of the first keypad.

4. The handheld device of claim 1, wherein the second body comprises a control unit electrically connected to the lighting element for controlling the lighting element to emit light.

5. The handheld device of claim 4, wherein the first body comprises a first triggering component and the second body comprises a second triggering component to which the control unit is electrically connected, the control unit controlling the lighting element to emit light when the first body slides relative to the second body to the predetermined position such that the first triggering component triggers the second triggering component.

6. The handheld device of claim 4, wherein the control unit is utilized for controlling the lighting element to emit light after a predetermined time when the first body slides relative to the second body to the predetermined position.

7. The handheld device of claim 4, further comprising a light sensor electrically connected to the control unit, wherein the control unit controls the lighting strength of the lighting element according to an ambient brightness detected by the light sensor.

8. The handheld device of claim 7, wherein when the ambient brightness detected by the light sensor is above a first threshold value, the control unit is utilized for controlling the lighting element not to emit light.

9. The handheld device of claim 7, wherein when the ambient brightness detected by the light sensor is below a second threshold value, the control unit is utilized for controlling the lighting element to emit light with maximum strength.

10. The handheld device of claim 7, wherein when the ambient brightness detected by the light sensor is between a first threshold value and a second threshold value, the control unit is utilized for controlling the lighting element to emit light with strength in inverse proportion to the ambient brightness detected by light sensor.

11. The handheld device of claim 7, wherein the control unit is utilized for controlling the lighting element by pulse width modulation (PWM) method such that the lighting element emits light in a period T₁ and changes its lighting strength between a maximum strength and a minimum strength;
wherein the period T₁=1/(M−X), where M is an input voltage required by the lighting element to emit light with the maximum strength, X is a sensing voltage generated by the light sensor detecting the ambient brightness, and X is proportional to the ambient brightness and not greater than M.

12. The handheld device of claim 4, wherein the control unit is utilized for controlling the lighting element by pulse width modulation (PWM) method as a battery module of the handheld device is being charged such that the lighting element emits light in a period T₂ and changes its lighting strength between a maximum strength and a minimum strength;
wherein the period T₂=1/(N−V), where N is a specified voltage of the battery module and V is a charging voltage of the battery module that is being charged.

13. The handheld device of claim 1, wherein the handheld device is a remote controller.
